(19) United States
(12) Patent Application Publication
(10) Pub. No.: US 2011/0113566 A1
(43) Pub. Date: May 19, 2011

(54) Multi-Functional Hand-Held Tool

(76) Inventor: Reese Holbrook, DePere, WI (US)

(21) Appl. No.: 12/946,433

(22) Filed: Nov. 15, 2010

Related U.S. Application Data
(60) Provisional application No. 61/261,532, filed on Nov. 16, 2009.

(51) Int. Cl. B25F 1/00; B66F 15/00; B25D 1/00

(52) U.S. Cl. 7/146; 7/166

(57) ABSTRACT

A multi-purpose tool, such as for use by truckers or other similar users, includes an elongated body having a first end and a second end, a striking member located at the first end, a prying member located at the second end, and a hook member located along an exterior surface of the body between the first and second ends. The striking member may be in the form of a hammer head having oppositely facing striking surfaces, and the prying member may be in the form of a crow bar contiguous with the body. The hook member may have a curvature opposite such that it faces in a direction away from the prying member. The tool may include a handle between the first and second ends, which may be grasped by the user when using the striking member.

### CROSS-REFERENCE TO RELATED APPLICATIONS

This application claims priority from U.S. Provisional Patent Application Ser. No. 61/261,532, filed on Nov. 16, 2009, the entirety of which is expressly incorporated by reference herein.

### BACKGROUND AND SUMMARY OF THE INVENTION

The present invention relates generally to hand-held tools and, more particularly, to a hand-held tool incorporating the features of a hammer, crowbar, and hook in a manner as may be used by those in the truck driving and transportation industry.

In the truck driving industry, it is not uncommon for truckers to keep a hammer, a hook, and a crowbar in the operating cab or elsewhere on the truck. Hammers are commonly used to drive nails or spikes while securing cargo, replace deck boards of the trailer, and loosen tie downs, etc. Hooks are commonly used to assist a user in disconnecting a trailer coupling pin from the fifth wheel on the rear of the towing truck. Crowbars are commonly used to loosen nails, pry blockings, release chocks from engaging tires, and move heavy loads. Heretofore, truckers and similar consumers who have a need for a hammer, a hook, and a crowbar, have been required to purchase and store each of these tools separately. Additionally, it is not uncommon for a user to need two or more of these tools to address the needs of a single project. It can add to the time needed to complete such a project, as well as user aggravation, if time must be spent locating each of the tools.

Therefore, one aspect of the present invention contemplates a multi-functional, multi-use hand held tool incorporating salient features of a hammer, a hook, and a crowbar.

Another aspect of the present invention contemplates a hand held tool for completing common trucking tasks in a safe and timely manner.

Another aspect of the present invention contemplates reducing the number of tools necessary for completing tasks common to long haul or over-the-road truckers, construction workers, and the like by means of incorporating salient features of a hammer, a hook, and a crowbar into a single hand held tool.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

In the drawings:

FIG. 1 is an isometric view of a multi-functional hand-held tool according to a representative embodiment of the present invention;

FIG. 2 is a top plan view of the multi-functional hand-held tool of FIG. 1;

FIG. 3 is a side elevation view of the multi-functional hand-held tool of FIG. 1; and

FIG. 4 is an end elevation of the multi-functional hand-held tool of FIG. 1.

### DETAILED DESCRIPTION OF THE DRAWINGS

The present invention will be described with respect to hand-held tool applications common amongst long haul or over-the-road truckers, but it is understood that the invention may also be applicable with other truck driving activities as well as non-truck driving activities, such as construction and demolition work.

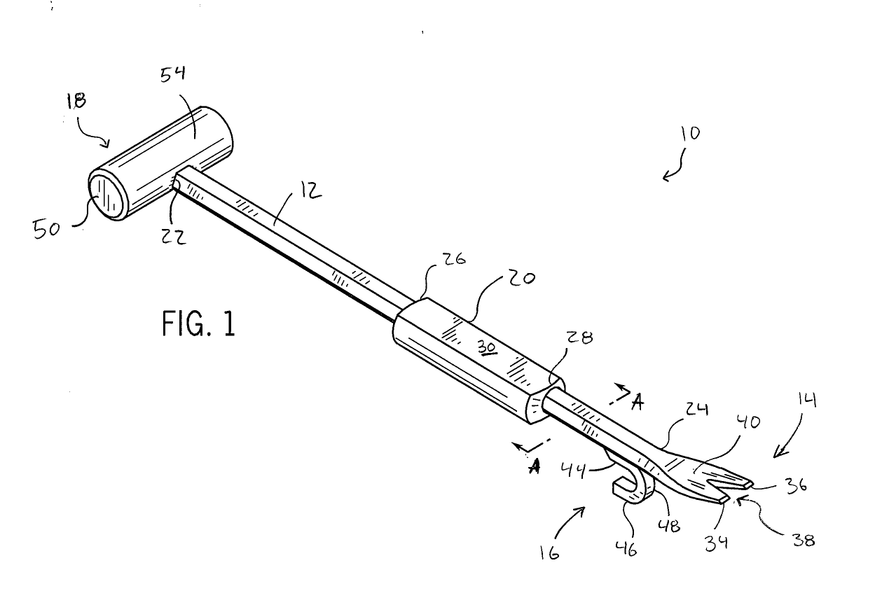

Referring initially to FIGS. 1-4, there is shown a tool 10 according to one embodiment of the present invention. The tool 10 generally includes an elongated body 12, a prying member, a hook member, and a striking member. As illustrated in FIGS. 1-4 the prying member may be a crowbar 14, the striking member may be a hammer head 18, and the hook member may be a standard hook 16. The body 12 is generally positioned between the hammer head 18 and the crowbar 14. As will be described in greater detail below, the body 12 may include a handle 20 that can be grasped by a user when using the hammer, hook, or crowbar features of the tool 10. The tool 10 may be drop forged in order to provide structural strength and durability, but may be formed by alternate fabrication techniques, such as casting. To provide additional strength, tool 10 or portions thereof may be case hardened to a hardness of RC40. Additionally, corrosion resistance may be obtained by coating the exterior surface of tool 10 with a black oxide coating, or alternative coating as are known in the art.

The body 12 of the tool 10 is in the form of an elongated shaft having a first end 22 that is secured to the hammer head 18, such as by welding, and a second end 24 that is contiguous with the crowbar 14. In this regard, the handle 20 has a first end 26 that is located toward the first end 22 of the body 12, and a second end 28 that is located toward the second end 24 of the body 12. The body 12 may representatively be hexagonal in cross section having a cross-sectional width of five eighths of an inch and a length of approximately thirteen inches, but may vary from this shape and dimension. In one embodiment the body 12 is made from medium tensile low hardenability carbon steel, such as 1045 steel.

The body 12 is aligned with the handle 20 such that a central longitudinal axis of the body 12 and handle 20 are coaxial. The handle 20 may be formed of a length of steel round bar, having a lengthwise bore through which the body 12 extends. Additionally, a top face 30 and a bottom face 32 may extend along the length of the handle 20, and the top face 30 and bottom face 32 may be arranged to lie in parallel planes. With this construction, the size and shape of the handle 20 enables the handle 20 to be held securely and comfortably in hand.

Handle 20 is affixed to body 12 such the first end 26 of handle 20 is spaced from the first end 22 of body 12 by a distance corresponding to the a grasping area of a conventional hammer handle. The handle 20 has a length sufficient to enable handle 20 to be grasped in the hand of a user, and the second end 28 of the handle 20 is spaced from the second end 24 of the body 12 by any satisfactory distance, e.g. 3 inches. Furthermore, as seen in FIG. 1, faces 30 and 32 are aligned as to be parallel with plane A, which runs lengthwise through the center of the body 12. The handle 20 may be affixed to body 12 by welding, or other means as is known in the art.

Alternatively, the handle 20 may be of solid construction, lacking a central bore. In such an embodiment, body 12 may be directly affixed to the first end 26 of the handle 20 by welding. Accordingly, crowbar 14 or a second portion of the body 12 may be directly affixed to the second end 28 of the handle 20. In yet another alternative, the handle 20 may be polygonal in cross section, wherein the two faces 30, 32 have a larger surface area than any remaining face. It is also contemplated that a slip resistant feature, such a rubber sheath, etching, or spray-on material, may be added to the handle 20 to improve handling of the tool 10.

As illustrated in FIGS. 1-3, crowbar 14 is contiguous with the second end 24 of the body 12. Crowbar 14 has a flattened top face 40 and bottom face 42. The top and bottom faces 40, 42 are slightly angled relative to the plane A, which runs lengthwise through the central axis of the body 12, similar to the angle of a conventional crowbar. In one embodiment, as seen in FIG. 3, the bottom face 42 is angled approximately 25 degrees from the central axis of the body 12. The ends of the top and bottom faces 40, 42 converge to form tapered teeth 34, 36. The teeth 34, 36 may be approximately 0.9 inches long and each may taper to an approximate width of 0.2 inches. The teeth 34, 36 may be divided by a tapered notch 38, which widens as it approaches the end of the teeth 34, 36.

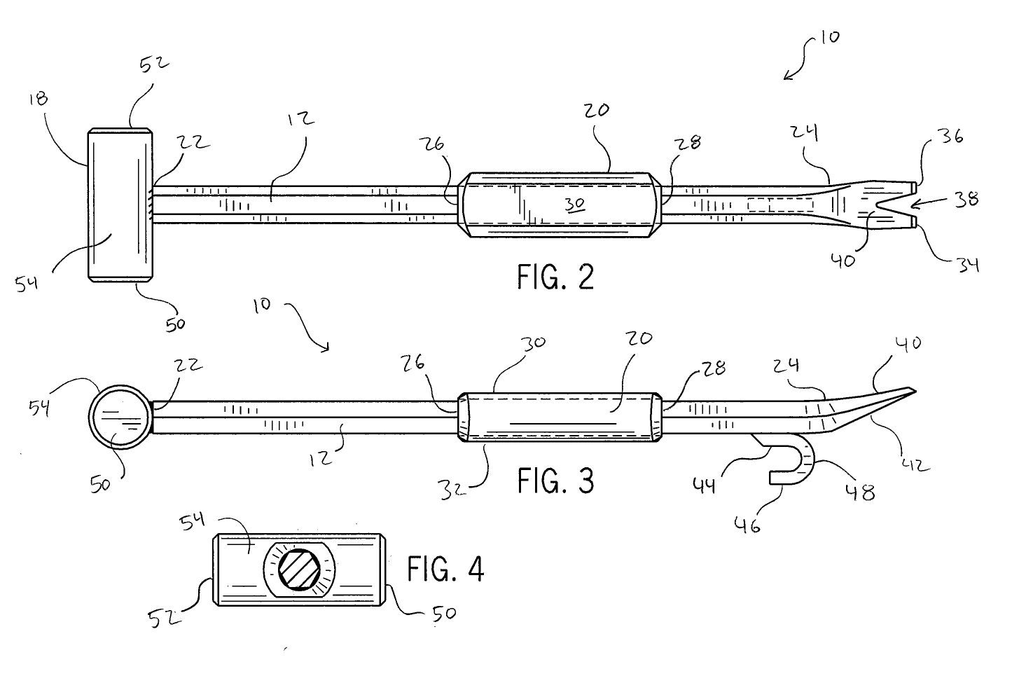

A trucker or other user may utilize the crowbar 14 to loosen nails, pry blockings, release chocks from engagement with tires, or move heavy loads. Tapered teeth 34, 36 may be placed between a chock and the tread surface of a tire, such that when the handle 20 is pushed towards the tire the bottom face 42 pivots away from the tread surface of the tire, thereby moving the chock. Similarly, the tapered teeth 34, 36 may be placed between a nail head and a surface, such that the nail rests in the notch 38, between tapered teeth 34, 36. When the handle 20 is pushed towards the surface, the bottom face 42 pivots away from the surface thereby raising the nail. Alternately, the tapered teeth 34, 36 may be wedged underneath a heavy load, such that when a force is applied downward onto the handle 20, the bottom face 42 pivots in a direction opposite that of the applied force, thereby raising the heavy load, and allowing it to be moved slightly. Turning now to FIGS. 1-3, the hook 16 includes at least a first leg 44 and an arcuate bight portion 48. As seen in FIG. 2, the hook 16 may also include a second leg 46, extending from the bight portion 48 opposite and spaced from the first leg 44. The legs 44, 46 and bight portion 48 of the hook 16 may be circular in cross section, and in one embodiment may be formed of one quarter inch diameter 1045 steel rod. It is also considered that the hook may be formed of a non-cylindrical steel rod, such as a rod having a square or rectangular cross-section, or any other shape. The first leg 44 may be straight, and have an approximate length of three quarters of an inch. The second leg 46 may also be straight, and have an approximate length of 0.4 inches. In one embodiment, the first and second legs 44, 46 may be parallel, as seen in FIG. 3. The bight portion 48 may have an approximate arc length of 1.15 inches, and be bent 180 degrees around a radius of 0.25 inches. It is also considered that the bight portion 48 may have a bend greater than or less than 180 degrees, while maintaining the function of hook 16. In an alternative embodiment, the first leg 44 may have a length of approximately one inch, and the bight portion 48 may have an arc length of approximately one inch, while lacking a second leg 46.

The hook 16 is affixed to the body 12, such that the bight portion 48 is positioned nearer to the two tapered teeth 34, 36 than is the first or second leg 44, 46. As positioned, the curvature of the bight portion 48 diametrically opposes the deflection of the crowbar 14. In other words, the hook 16 is curved toward the hammer head portion 18 of the tool 10.

Further the central longitudinal axis of the first leg 44 is parallel to the central longitudinal axis of the body 12. The hook 16 may either be formed integrally with the tool 10, or formed separately and affixed to the body 12 along the length of the first leg 44 of the hook 16 in a conventional manner, e.g., welding. As demonstrated in FIG. 3, the end of first leg 44 may also by angled towards the body 12, thereby directing an object into the center of the hook 16, and reducing the potential for unintentionally snaring objects on a flat end of first leg 44.

A trucker or other user may utilize the hook 16 to aid in disconnecting a semi-trailer coupling pin from the fifth wheel on the rear of a towing vehicle. The use of the hook 16 is believed to improve safety and cleanliness by minimizing the trucker's need for hands-on involvement while disconnecting the fifth wheel. Further, the use of the hook 16 is believed to improve the efficiency and ease with which a trucker may position and secure tire chains, especially during inclement weather. Also, the hook 16 may be used to reach objects such as tie down chains that are either difficult to reach or located in unclean areas.

As shown in FIGS. 1-4, the hammer head 18 includes at least a first striking surface 50 and a body 54. As seen in FIGS. 2 and 4, the hammer head 18 may also have a second striking surface 52. In one embodiment the hammer head 18 is configured as a double-faced mallet, including striking surfaces 50, 52 and a body 54. In such a configuration, the hammer head 18 may form a right circular cylinder such that the striking surfaces 50, 52 are parallel circular planes forming the top and bottom of the cylinder and the body 54 forms the curved wall of the cylinder. Accordingly, the central longitudinal axis of the hammer head 18 forms a right angle with the planes of the two striking surface 52, 54. The double-faced mallet of such an embodiment may be formed of a length of steel bar, having any satisfactory diameter and length, such as a diameter of 1¼ inches and a length of three inches, although alternative dimensions and hammer shapes may be incorporated into the tool 10. The hammer head 18 is preferably joined to the elongated body 12 such that the body 54 of the hammer head 18 is centered on the elongated body 12. The hammer head 18 is joined to the body 12 such that the central longitudinal axis of the hammer head body 54 is perpendicular to the central longitudinal axis of the elongated body 12, as depicted in plane A of FIG. 1. Further, the central longitudinal axis of the hammer head body 54 lies perpendicular to the plane which bisects both the tapered notch 38 of the crowbar 16 and the arcuate let 48 of the hook 16. When using the crowbar 14 and/or the hook 16, the user may advantageously grasp the hammer head 18 for use as a handle to provide maximum leverage.

While the hammer head 18 is described above as having mallet type configuration, it is understood that the hammer head 18 could be constructed to have other hammer type features, such as those of a claw hammer, a cross-peen hammer, or a ball peen hammer.

A trucker or other user may utilize the hammer head 18 to drive nails or spikes while securing cargo, to loosen tie downs, and to check tire status. Grasping tool 10 by handle 20, the trucker may swing the tool downwards to strike a nail or spike with either striking surface 50, 52. Tool 10 may be similarly swung at taut tie downs, so as to deliver the necessary force required to loosen or disengage the tie down. Also, tool 10 may be similarly swung lightly at the side walls of tires to gauge the pressure of the tire based on the resulting physical and audible vibrations produced after contact.

In addition to the description of tool 10 above, it is contemplated that the hammer portion, the hook portion, or the crowbar portion could be replaced with other types of tooling features, such as a chisel, a punch, a blade, and the like.

Tool 10 of the present invention combines the various means of performing common tasks associated with truck driving in a single device. The present invention decreases the need for multiple tools, thereby offering a cost effective and simple solution for performing these common tasks. Furthermore, tool 10 increases the cleanliness and safety of performing such tasks, while simultaneously increasing the efficiency of the user.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

I claim:

1. A multi-purpose tool comprising:
an elongated body having a first end and a second end;
a striking member located at the first end of the body;
a prying member located at the second end of the body; and
a hook member located along an exterior surface of the body.

2. The multi-purpose tool of claim 1 wherein the striking member is a hammer head.

3. The multi-purpose tool of claim 2 wherein the hammer head has a first striking surface.

4. The multi-purpose tool of claim 3 wherein the hammer head has a second striking surface, wherein the first and second striking surfaces face in opposite directions.

5. The multi-purpose tool of claim 1 wherein the striking member is affixed at the first end of the elongated body.

6. The multi-purpose tool of claim 5 wherein the striking member is welded at the first end of the elongated body.

7. The multi-purpose tool of claim 1 wherein the prying member is a crow bar.

8. The multi-purpose tool of claim 7 wherein the crow bar comprises a first and second tooth separated by a tapered notch.

9. The multi-purpose tool of claim 1 wherein the prying member is contiguous with the elongated body.

10. The multi-purpose tool of claim 7 wherein the crow bar is acutely angled relative to a longitudinal axis along which the elongated body extends.

11. The multi-purpose tool of claim 10 wherein a longitudinal axis of the crow bar is perpendicular a longitudinal axis of the striking member.

12. The multi-purpose tool of claim 1 wherein the hook member has a curvature of substantially one hundred and eighty degrees.

13. The multi-purpose tool of claim 1 wherein the curvature of the hook member is directed opposite an angle of the prying member.

14. The multi-purpose tool of claim 1 wherein the hook member is affixed to the exterior surface of the elongated body adjacent the second end.

15. The multi-purpose tool of claim 14 wherein the hook member is welded to the exterior surface of the elongated body adjacent the second end.

16. The multi-purpose tool of claim 1 further comprising a handle associated with the elongated body between the first and second ends, wherein the elongated body has a first transverse dimension and the handle has a second transverse dimension greater than the first transverse dimension.

17. The multi-purpose tool of claim 1 wherein at least a portion of the tool is formed by drop forging.

18. The multi-purpose tool of claim 1 wherein at least a portion of the tool is case hardened.

19. A multi-purpose tool comprising:
an elongated body having a first end, a second end, and a handle interposed therebetween, wherein the body extends along a longitudinal axis;
a striking member located at the first end of the body, wherein the striking member comprises a dual-faced mallet;
a crow bar prying member located at an acute angle relative to the longitudinal axis of the body at the second end of the body, wherein the crow bar prying member comprises two teeth and a tapered notch therebetween; and
a hook member extending outwardly from the body adjacent the second end of the body, wherein the hook member further has an entrance area that faces away from the crow bar prying member.
